(19) United States
(12) Patent Application Publication
(10) Pub. No.: US 2024/0399604 A1
(43) Pub. Date: Dec. 5, 2024

(54) SLICING MACHINE, ESPECIALLY SLICER

(71) Applicant: MULTIVAC SEPP HAGGENMÜLLER SE & CO. KG, Wolfertschwenden (DE)

(72) Inventor: Luciano CAPRIOTTI, Markt Rettenbach (DE)

(73) Assignee: MULTIVAC SEPP HAGGENMÜLLER SE & CO. KG, Wolfertschwenden (DE)

(21) Appl. No.: 18/676,005

(22) Filed: May 28, 2024

(30) Foreign Application Priority Data
Jun. 2, 2023 (DE) 102023114558.4

(51) Int. Cl. B26D 7/02; B26D 1/00; B26D 5/20

(52) U.S. Cl. CPC B26D 7/02; B26D 1/0006; B26D 5/20; B26D 2001/0093

(57) ABSTRACT

A slicing machine for slicing at least one product caliber into slices and for producing portions from the slices, includes a cutting unit with a blade, in particular a rotatable blade that is movable in a cutting plane, for cutting slices from the at least one product caliber, a feed unit for feeding the product calibers to the cutting unit along a feed direction, and a gripper unit with at least one gripper which is movable along the feed direction. The gripper unit comprises a claw drive unit by which gripper claws of the at least one gripper are displaceable between an engagement position in which the gripper claws hold the product caliber and a release position in which the gripper claws do not hold the product caliber. Furthermore, the claw drive unit is configured as an electromagnetically actuated claw drive unit.

### CROSS-REFERENCE TO RELATED APPLICATIONS

This application claims priority to German Patent Application No. DE 102023114558.4 filed on Jun. 2, 2023, the disclosure of which is incorporated in its entirety by reference herein.

### TECHNICAL FIELD

The invention relates to slicing machines, in particular so-called slicers, which are used in the food industry to slice strands of an only slightly compressible product such as sausage or cheese.

### BACKGROUND

Since these strands can be produced with a cross-section that maintains its shape and dimensions well over their length, i.e. remains essentially constant, they are called product calibers.

In most cases, several product calibers arranged parallel to one another on individual tracks are cut side by side at the same time by cutting one slice at a time by the same blade, which moves in a transverse direction to the longitudinal direction of the product caliber.

The product calibers are moved forwards by a feed conveyor of a feed unit towards the blade of the cutting unit, usually on a downwardly inclined feed conveyor, and are guided in each case through the product openings of a plate-type so-called cutting frame, at whose front ends the part of the product caliber projecting beyond it is cut off as a slice by the blade immediately in front of the cutting frame.

During slicing, the product calibers are usually held at their rear end facing away from the cutting frame by a gripper which is equipped with corresponding gripper claws to prevent uncontrolled downward movement of the product calibers.

The slicing machines often have a multi-track design, which means that the feed unit feeds several adjacent product calibers, each held at the rear end by a gripper, to the cutting unit which cuts a slice from each of the product calibers, virtually simultaneously, in one working cycle of the single blade.

The gripper claws of the grippers are driven by a claw drive unit, which is usually configured as a pneumatically actuated claw drive unit. For this purpose, a corresponding pneumatic cylinder must be provided on each claw drive unit, i.e. on each gripper, and above all a pneumatic supply line and the like, which requires a gripper of complex design and presents a high risk of damage.

Moreover, such pneumatic cylinders carry a greater risk of failure and must be maintained carefully, as even the smallest amounts of lubricant or unclean, particularly oil-bearing, compressed air escaping from the pneumatic cylinder can lead to contamination of the food being processed.

Also, the gripper claws of pneumatically actuated grippers often can only be actuated at a very limited speed, which means that the gripper claws can only be opened or closed correspondingly slowly. The forces acting on the gripper are also difficult or impossible to determine with pneumatic drives.

Grippers driven by spindle actuators have already been proposed to overcome this problem, but these often prove to be very complex and therefore cost-intensive, for which reason spindle actuators are also unsuitable for many applications.

### SUMMARY

It is therefore the task according to the disclosure to provide a slicing machine, in particular a slicer, which can overcome these problems, in particular by means of a solution in which the design complexity of the grippers, in particular the claw drive unit, and associated parts of the slicing machine is reduced and the product calibers can be held reliably and securely.

This task is solved by the features of claim 1. Advantageous embodiments result from the dependent claims.

A generic multi-track slicing machine, such as a slicer, for slicing at least one product caliber into slices and creating portions from the slices typically comprises
a cutting unit with a blade, in particular a rotatable blade, that is movable in a cutting plane, for cutting slices from the at least one product caliber,
a feed unit with a feed conveyor for feeding the product calibers to the cutting unit along a feed direction and a gripper unit with at least one gripper which is movable along the feed direction and comprises a claw drive unit by means of which gripper claws of the at least one gripper
   are displaceable between an engagement position in which the gripper claws hold the product caliber, and
   a release position in which the gripper claws do not hold the product caliber, and
a control unit for controlling moving parts of the slicing machine.

According to the invention, the claw drive unit is configured as an electromagnetically actuated claw drive unit.

Since the claw drive unit according to the invention is configured as an electromagnetically actuated claw drive unit, the pneumatic components mentioned at the outset, such as pneumatic supply lines and the like, in the area of the gripper can be dispensed with, which means that not only the claw drive unit but also the entire gripper can be of significantly simpler design. The elimination of the pneumatic system also means that there is no risk of leaks and thus of lubricants and/or unclean, in particular oil-bearing, compressed air escaping from the pneumatic cylinder, thus minimizing the risk of contamination of the product calibers to be processed and increasing the process reliability of the slicing machine.

In a multi-track slicing machine, this has a correspondingly positive effect on the entire gripper unit, which usually has one gripper attached to each track.

The electromagnetically actuated claw drive unit according to the invention also has gripper claws that operate at a higher actuation speed, i.e. opening or closing speed, compared to pneumatically actuated claw drive units, thus for example improving, in particular reducing, a cycle time of the slicing machine.

In principle, the electromagnetically actuated claw drive unit can be connected to the gripper claws of the gripper in any suitable way, so that an actuation, i.e. movement, of the claw drive unit can be translated into a corresponding opening or closing movement of the gripper claws. Also, a corresponding transmission device through which the actuating force acting on the gripper claws and/or an actuating torque of the gripper claws is increased can, if necessary, be arranged between the claw drive unit and the gripper claws.

According to a preferred embodiment, however, the claw drive unit comprises an electromagnet which is adapted to drive a drive element, in particular a coupling rod, of the claw drive unit in and/or against the feed direction along a substantially linear stroke. The drive element, in particular the coupling rod, can be connected to the gripper claws via a toothing, for example. For this purpose, it is conceivable, for example, to provide a toothing on the drive element which engages with a corresponding counter-toothing, in particular one or more pinions, which is connected to the gripper claws, in particular in a rotationally fixed manner.

The electromagnet can be configured in a manner known per se like a conventional electromagnetic actuator with a solenoid, which comprises a coil on which a magnetic field can be generated by applying an electrical voltage, causing an armature arranged inside the coil, which is preferably connected to the drive element, to move in a linear first direction or in a second direction opposite to the first direction. The first direction can correspond to the feed direction, for example, so that the second direction can run in the opposite direction to the feed direction. The direction of movement of the armature and thus of the drive element, in particular the coupling rod, can be determined by the corresponding polarity of the voltage. For this purpose, the electromagnet can be connected to the control unit of the slicing machine for actuation. The electromagnet can also be actuated by applying the voltage, for example in only one actuating direction, i.e. the first direction or the second direction, the armature being reset against the actuating direction by means of a return spring connected to it. Furthermore, the movement of the armature of the magnet in the first direction and in the second direction can each be limited by a stop element, the armature preferably being displaceable between two stop positions, each of which is defined by a stop element. In particular, the armature and/or the stop element are made of a magnetic material such as iron, another magnetic metal or similar.

In a further development of this exemplary embodiment, the linear stroke of the electromagnet in the feed direction can be from 5 mm to 50 mm, in particular from 10 mm to 25 mm. Defining the extent of the linear stroke in this way means on the one hand that a sufficient actuation path and/or a sufficient actuation force of the gripper claws can be achieved, while on the other hand the claw drive unit and thus the gripper can still have comparatively compact dimensions.

To be able to control and/or monitor preferably each gripper of the slicing machine as well as possible during operation of the slicing machine, according to a further exemplary embodiment at least one signal output of the claw drive unit can be in signal connection with at least one signal input of the control unit of the slicing machine, the control unit being adapted to receive signals from the claw drive unit which indicate a claw position and/or a claw current and/or a claw voltage. From the claw position it is possible to determine, for example, whether the gripper claws are in the desired position or whether there may be a fault that is preventing the desired actuation of the gripper claws. Essentially the same applies to the claw current and or the claw voltage.

In a further development of this exemplary embodiment, from the signals received from the claw drive unit, the control unit can be adapted to detect a gripper force acting on the at least one gripper. This not only allows an overload of the claw drive unit and/or the gripper claws to be detected and in the best case prevented, but also means that it is possible to draw conclusions about the consistency of the product caliber held by the respective gripper. The control unit of the slicing machine can therefore preferably be adapted to detect the gripper force and from this to detect a consistency of the product caliber held by the gripper. This can improve the cutting result of the slicing machine, as a consistency of the product caliber that is too soft or too hard, which indicates, for example, that the temperature of the product caliber is too high or too low, can be detected before the product caliber is sliced and the system can react accordingly. For example, the control unit can output a warning via a user interface of the slicing machine to a slicing machine operator, who can then respond by replacing the product caliber or adjusting the temperature of the product caliber, for example.

To be able to provide a suitable gripper force at the gripper claws for the respective application, according to a preferred exemplary embodiment, the electromagnetically actuated claw drive unit can be adapted to actuate the gripper claws with a claw force of 80 N to 3000 N, in particular 800 N to 1500 N. If the claw drive unit comprises, for example, the electromagnet described above, it must be taken into account that an actuating force of the electromagnet, which is decisive for the claw force acting on the gripper claws, can vary over the stroke of the electromagnet, in particular be non-linear. For example, the electromagnet can have a comparatively low actuating force at the start of the stroke and/or the actuating force can increase sharply, in particular exponentially, in the end portion of the stroke.

To furthermore be able to draw conclusions about the distance traveled by the gripper drive unit, in particular the drive element, and/or about a position of the drive element and/or the gripper claws, the claw drive unit can also comprise a displacement sensor and/or a position sensor for the gripper claws, in particular a displacement transducer and/or a differential transformer. At least one signal output of each of the aforementioned sensors can be connected to a corresponding signal input of the control unit of the slicing machine so that the control unit can process the received signals accordingly.

It should also be added that the slicing machine can be configured as a multi-track slicing machine with multiple tracks, wherein, in particular, the feed unit can comprise a gripper carriage, which carries one gripper per track, and a carriage guide along which the gripper carriage can be moved in a controlled manner in and/or against the feed direction.

Finally, the slicing machine can also comprise, in a manner known per se, a discharge unit with a discharge conveyor, in particular a portioning belt, for the slices.

### BRIEF DESCRIPTION OF THE DRAWINGS

Embodiments according to the invention are described in more detail below by way of example. The following are shown:

FIGS. 1A, B: A known slicing machine in the form of a slicer according to the prior art in different perspective views, with the feed belt raised to the slicing position.

FIG. 2A: A simplified side view of the slicing machine according to the prior art, loaded with a product caliber, in a first functional position.

FIG. 2B: A side view as shown in FIG. 2a, but with the feed belt lowered to the loading position and with the product caliber sliced, except for a caliber end-piece.

FIG. 3: A sectional view of a gripper according to the invention which comprises an electromagnetically actuated claw drive unit.

### DETAILED DESCRIPTION

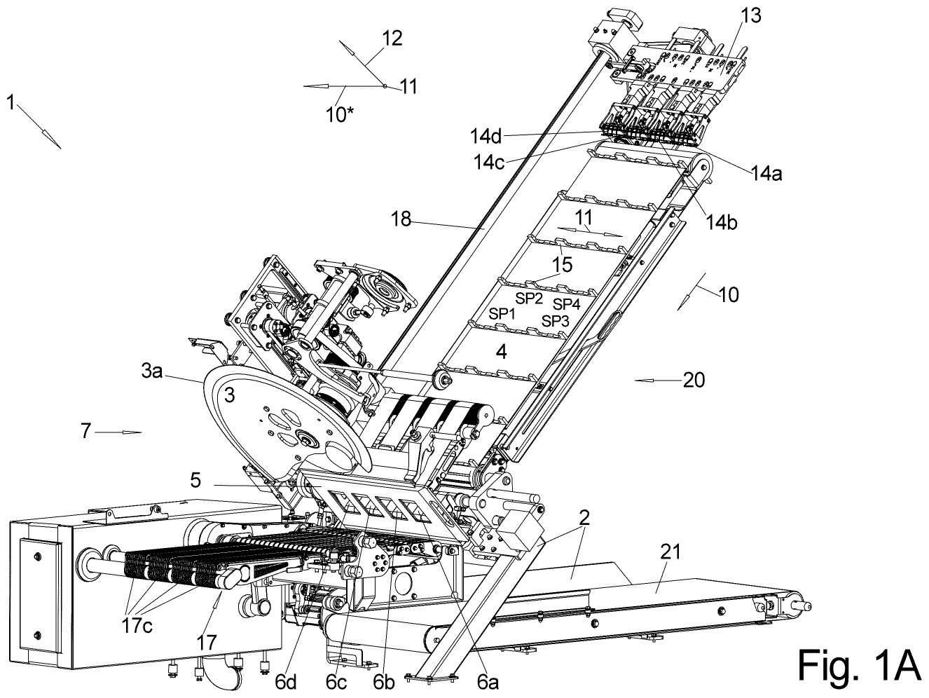

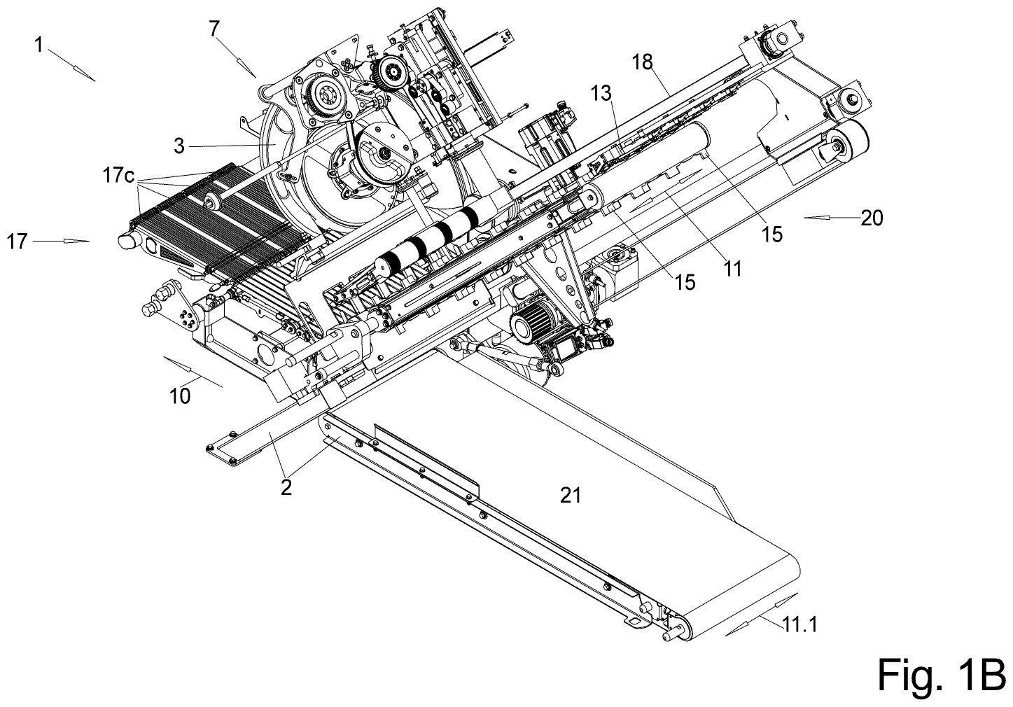

FIGS. 1A, 1B show different perspective views of a multi-track slicer 1 for the simultaneous slicing of multiple product calibers K—not shown for the sake of clarity—each on one track SP1 to SP4 lying adjacent to one another, and depositing them in shingled portions P each consisting of multiple slices S, with a general throughput direction 10* through the slicer 1 from right to left.

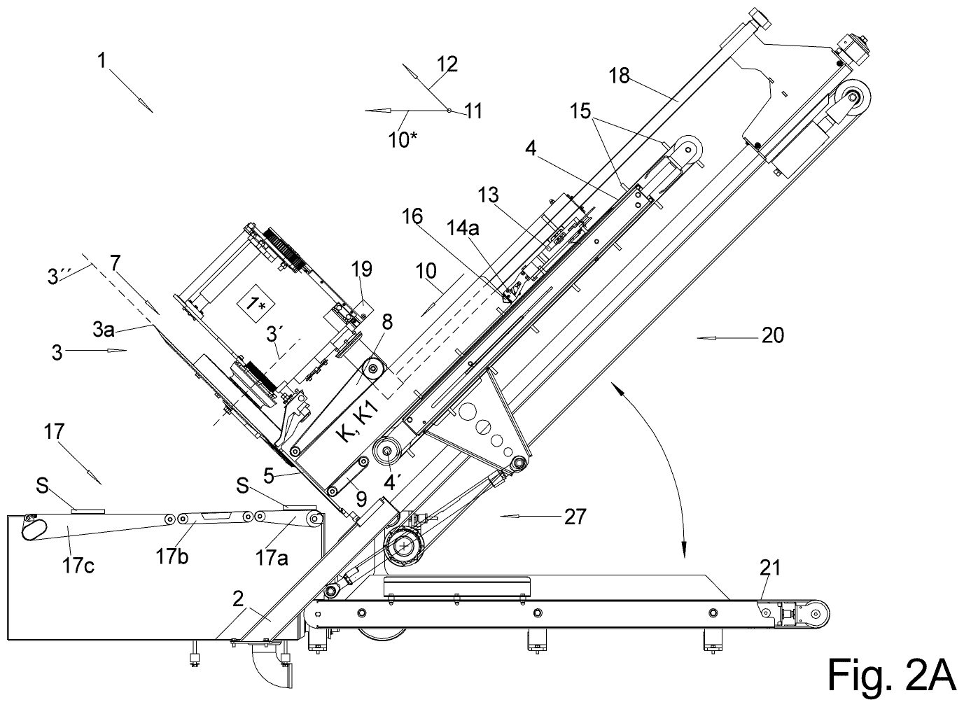

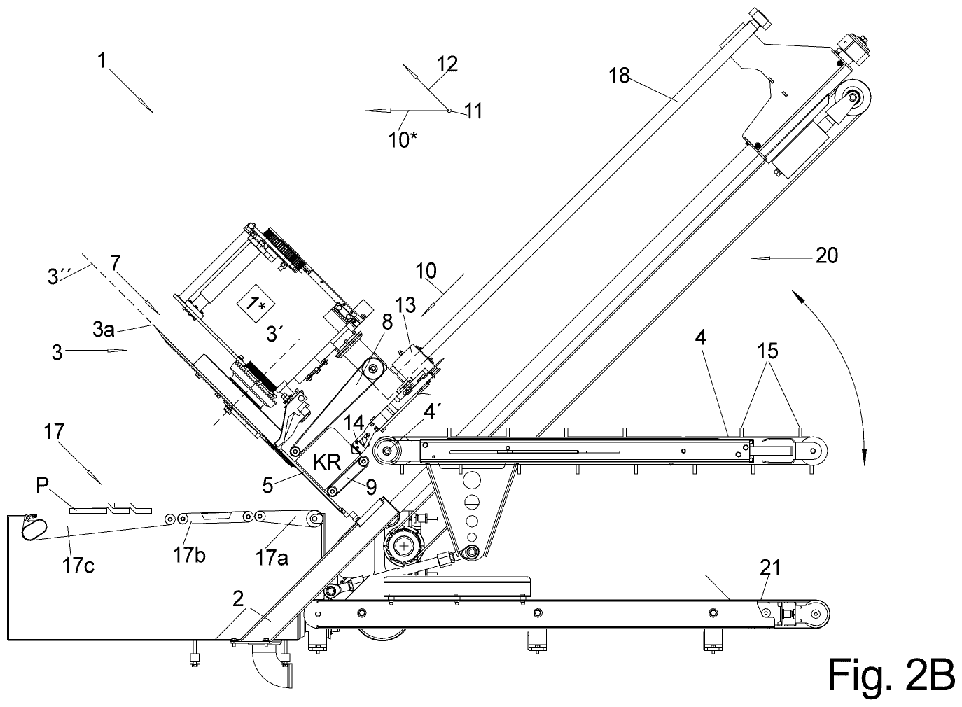

FIG. 2A and FIG. 2B show—with caliber K inserted—a side view of this slicer 1, omitting covers and other parts not relevant to the invention which like all other units are attached to the base frame 2, so that the functional parts, especially the conveyor belts, are more clearly visible. The longitudinal direction 10 is the feed direction of the caliber K to the cutting unit 7 and thus also the longitudinal direction of the caliber K lying in the slicer 1.

It can be seen that the basic structure of a slicer 1 according to the prior art consists in the fact that several, in this case four, product calibers K lying adjacent to one another on a feed conveyor 4 lying transversely to the feed direction 10 with spacers 15 of the feed conveyor 4 arranged between them are fed by this feed unit 20 to a cutting unit 7 with a blade 3, such as a sickle blade 3, rotating about an axis of rotation 3′, from whose front ends the rotating blade 3 cuts off a slice S with its cutting edge 3a in a single operation, i.e. almost simultaneously.

For slicing the product caliber K, the feed conveyor 4 is in the inclined slicing position shown in FIGS. 1A-2A, with the cutting-side front end lying low and the rear end lying high, from which it can be lowered about a pivot axis 4′ running in its width direction, the first transverse direction 11, located close to the cutting unit 7, to an approximately horizontal loading position, as shown in FIG. 2B.

According to FIG. 2A, the rear end of each caliber K lying in the feed unit 20 is held in a form-fitting manner by a gripper 14a-d with the aid of gripper claws 16. These grippers 14a-14d, which can be activated and deactivated with respect to the position of the gripper claws 16, are attached to a common gripper carriage 13 which can be moved along a gripper guide 18 in the feed direction 10. The gripper claws 16 are attached to the gripper 14 in a movable manner, i.e. they are movable between an engagement position and a release position.

The feed of both the gripper carriage 13 and the feed conveyor 4 can be driven in a controlled manner, but the actual feed speed of the caliber K is determined by a so-called upper and lower driven product guide 8, 9, which is also driven in a controlled manner, in the form of circulating belts that engage the upper and lower sides of the caliber K to be sliced in their front end portions close to the cutting unit 7.

The front ends of the calibers K are each guided through a so-called product opening 6a-d of a plate-type cutting frame 5, the cutting plane 3″ in which the blade 3 rotates with its cutting edge 3a—and thus cuts off the end of the calibers K projecting from the cutting frame 5 as a slice S—running immediately in front of the front, downwardly inclined end face of the cutting frame 5. The cutting plane 3″ runs perpendicularly to the upper run of the feed conveyor 4 and/or is spanned by the two transverse directions 11, 12 to the feed direction 10.

The inner circumference of the product openings 6a-d serves as a counter-edge of the cutting edge 3a of the blade 3.

Since both product guides 8, 9 can be driven in a controlled manner, in particular independently of each other and/or possibly separately for each track SP1 to SP4, these determine the—continuous or timed—feed speed of the caliber K through the cutting frame 5.

The upper product guide 8 can be displaced in the second transverse direction 12—which runs perpendicularly to the surface of the upper run of the feed conveyor 4—in order to adapt to the height H of the caliber K in this direction. Furthermore, at least one of the product guides 8, 9 can be configured to be pivotable about one of its pulleys in order to be able to change, to a limited extent, the direction of the run of its guide belt in contact with the caliber K.

Below the feed unit 20 there is usually a roughly horizontal end-piece conveyor 21 which starts with its front end below the cutting frame 5 and immediately below or behind the discharge unit 17, and transports end-pieces falling onto it away towards the rear with its upper run, via the drive of one of the discharge conveyors 17 against the throughput direction 10*.

The slices S standing obliquely in the space while they are being cut fall onto a conveyor unit 17 which starts below the cutting frame 5 and runs in the throughput direction 10* and which in this case consists of a plurality of discharge conveyors 17a, b, c arranged approximately in alignment one after the other in the throughput direction 10*, of which the first conveyor 17a in the throughput direction 10* can be configured as a portioning belt 17a and/or of which one can also be configured as a weighing unit.

The slices S can arrive on the discharge unit 17 individually and spaced apart from one another in the general throughput direction 10* of the products through the machine or, by appropriate control of the portioning belt 17a of the discharge unit 17—whose movement, like almost all moving parts, is controlled by the control unit 1*—can form shingled or stacked portions P through stepwise forward movement of the portioning belt 17a.

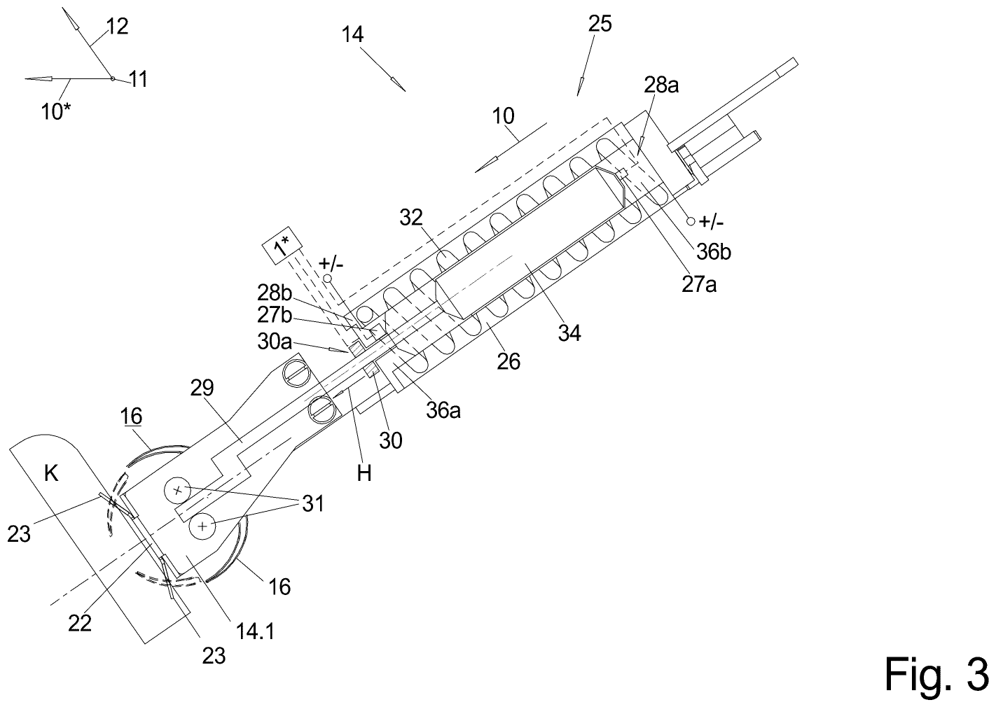

FIG. 3 shows a sectional view of a gripper 14 according to the invention. If the slicing machine 1 according to the invention is configured as a multi-track slicing machine 1, each of the grippers 14a-14d in FIG. 1A can be configured according to the gripper 14 shown in FIG. 3.

The gripper 14 shown in FIG. 3 comprises a claw drive unit 25, which according to the invention is designed as an electromagnetically actuated claw drive unit. For this purpose, according to the illustrated exemplary embodiment, the gripper 14 comprises an electromagnet 26. The electromagnet 26 comprises a coil 32 on which a magnetic field can be generated by applying an electrical voltage which can act within the coil essentially in or against the feed direction 10, depending on the polarity of the electrical voltage. In FIG. 3, the poles of the coil 32 are simply marked “+/−”, which means that each of the poles can serve either as a positive pole or as a negative pole, depending on the direction in which the magnetic field is to act.

By applying the electrical voltage to the coil 32 and thus generating the aforementioned magnetic field within the coil 32, an armature 34 arranged inside the coil 32 is caused to move in or against the feed direction 10. The armature 34 is connected to a drive element 29, which in the example shown is configured as a coupling rod 29. A movement of the armature 34 therefore leads to a corresponding movement of the coupling rod 29. The movement of the armature 34 in or against the feed direction 10 is limited by a stop element 36a or 36b. The stop elements 36a and 36b are preferably arranged on opposite sides of the armature 34 in the feed direction 10. The armature 34 and thus the electromagnet 26 and the claw drive unit 25 are therefore preferably displaceable between two end stop positions defined by the stop elements 36a and 36b. The armature 34 and/or the stop elements 36a and 36b are made of a magnetic material such as iron, a ferrous material or similar.

The coupling rod 29, which in the illustrated exemplary embodiment is led out of the electromagnet 26 in the feed direction 10, engages in the area of the gripper claws 16 with opposingly arranged pinions 31, which are preferably non-rotatably connected to the gripper claws 16 of the gripper 14. For this purpose, the coupling rod 29 can have a toothing (not shown) at least at its end lying in the feed direction 10, which engages with a corresponding counter-toothing (also not shown), formed on each of the pinions 31. This allows the gripper claws 16 to be displaced between their engagement position, in which the gripper claws 16 hold the product caliber K, and their release position, in which the gripper claws 16 do not hold the product caliber K. The stroke H of the armature 34 and thus of the coupling rod 29 is preferably chosen such that the gripper claws 16 are in the engagement position when the armature 34 is in contact with the stop element 36b (as shown in FIG. 3), and the gripper claws 16 are in the release position when the armature 34 is in contact with the stop element 36a.

To furthermore be able to draw conclusions about the distance traveled by the gripper drive unit 25, in particular the coupling rod 29, and/or about a position of the armature 34 and thus of the gripper claws 16, the claw drive unit 25 can also comprise a displacement sensor 30 and/or position sensors 27a and 27b for the gripper claws 16. For this purpose, corresponding signal outputs 28a and 28b of the position sensors 27a and 27b and a signal output 30a of the displacement sensor 30 can each be connected to a corresponding signal input of the control unit 1* of the slicing machine 1.

The control unit 1* also makes it possible, for example, to detect a gripper force acting on the gripper claws 16 from the travel of the coupling rod 29 detected by the travel sensor 30 combined with a current and/or voltage applied to the coil 32.

### LIST OF REFERENCE NUMBERS

1 Slicing machine, slicer
1* Control unit
2 Base frame
3 Blade
3′ Axis of rotation
3″ Blade plane, cutting plane
3a Cutting edge
4 Feed conveyor, feed belt
4′ Pivot axis
5 Cutting frame
6a-d Frame opening
7 Cutting unit
8 Upper product guide, upper guide belt
9 Lower product guide, lower guide belt
10 Feed direction
10* Throughput direction through machine
11 1. Transverse direction (across width of slicer)
12 2. Transverse direction (in height direction of caliber)
12* Vertical
13 Gripper unit, gripper carriage
13.1 Projection
13.2 Mounting section
13.2 Projection
13.4 Mounting section
14,14 a-d Gripper
15 Spacer
15′ Support surface
15″ Feed plane
16 Gripper claw
17 Discharge unit
17a, b, c Portioning belt, discharge conveyor
18 Gripper guide
20 Feed unit
21 End-piece conveyor
22 End-piece ejector
23 Scraper
25 Claw drive unit
26 Electromagnet
27a, 27b Position sensor
28a, 28b Signal output
29 Drive element, coupling rod
30 Displacement sensor
30a Signal output
31 Pinion
32 Coil
34 Armature
36a, 36b Stop element
S Slice
P Portion

1. A slicing machine for slicing a product caliber into slices and for producing portions from the slices, the slicing machine comprising:
a cutting unit with a blade for cutting slices from the product caliber, and
a feed unit with a feed conveyor for feeding the product caliber to the cutting unit along a feed direction and a gripper unit with at least one gripper which is movable along the feed direction and comprises gripper claws and a claw drive unit by which the gripper claws of the at least one gripper
are displaceable between an engagement position, in which the gripper claws hold the product caliber, and
a release position in which the gripper claws do not hold the product caliber,
and wherein
the claw drive unit is configured as an electromagnetically actuated claw drive unit.

2. The slicing machine according to claim 1, wherein
the claw drive unit comprises a drive element and an electromagnet which is adapted to drive the drive element in and/or against the feed direction along a substantially linear stroke.

3. The slicing machine according to claim 2, wherein
the linear stroke of the electromagnet in the feed direction is from 5 mm to 50 mm.

4. The slicing machine according to claim 1, further comprising a control unit, wherein
at least one signal output of the claw drive unit is in signal connection with at least one signal input of the control unit,
the control unit being adapted to receive signals from the claw drive unit which indicate a claw position and/or a claw current and/or a claw voltage.

5. The slicing machine according to claim 4, wherein
the control unit is adapted to detect, from the signals received from the claw drive unit, a gripper force acting on the at least one gripper.

6. The slicing machine according to claim 1, wherein
the electromagnetically actuated claw drive unit is adapted to actuate the gripper claw with a gripper force of 80 N to 3000 N.

7. The slicing machine according to claim 1, wherein
the claw drive unit comprises a displacement sensor and/or a position sensor for the gripper claws.

8. The slicing machine according to claim 1, wherein
the slicing machine is configured as a multi-track slicing machine with multiple tracks,
the at least one gripper comprises multiple grippers, and
the feed unit comprises a gripper carriage which carries one of the grippers per track, and a carriage guide along which the gripper carriage can be moved in a controlled manner in the feed direction.

9. The slicing machine according to claim 1, further comprising
a discharge unit with a conveyor, for the slices.

10. The slicing machine according to claim 2, wherein the drive element comprises a coupling rod.

11. The slicing machine according to claim 3, wherein the linear stroke of the electromagnet in the feed direction is in a range of 10 mm to 25 mm.

12. The slicing machine according to claim 1, wherein the electromagnetically actuated claw drive unit is adapted to actuate the gripper claws with a gripper force in a range of 800 N to 1500 N.

13. The slicing machine according to claim 7, wherein the displacement sensor or the position sensor comprises a displacement transducer or a differential transformer.

14. The slicing machine according to claim 9, wherein the conveyor of the discharge unit comprises a portioning belt.
